(19) United States
(12) Patent Application Publication
(10) Pub. No.: US 2013/0050525 A1
(43) Pub. Date: Feb. 28, 2013

(54) PORTABLE THEATRICAL LIGHTING CONTROL AND AUDIOVISUAL RECORDING SYSTEM

(71) Applicant: MASOUD MOTLAQ ALSAID, ALKOUSOR (KW)

(72) Inventor: MASOUD MOTLAQ ALSAID, ALKOUSOR (KW)

(21) Appl. No.: 13/219,575

(22) Filed: Aug. 26, 2011

(51) Int. Cl. H04N 5/76

(52) U.S. Cl. 348/231.4; 348/E05.031

(57) ABSTRACT

The portable theatrical lighting control and audiovisual recording system enables the director of a stage or motion picture production to control the lighting and various other technical aspects of the production simultaneously with his or her direction of the performers. The system includes a case containing three DMX 512 format lighting control boards or panels, a computer system having a video monitor display, a miniature camera and DVD recorder and player for capturing a video of the performance, and various other features, such as ports for the connection of peripherals (a keyboard, printer, computer mouse, headphones, etc.). The lid or cover of the case includes a storage tray for the various electrical and power cords and cables associated with the system, the lid and case including carrying handles for transport of the device when not in use.

### BACKGROUND OF THE INVENTION

1. Field of the Invention

The present invention relates to lighting control and audiovisual equipment, and particularly to a portable theatrical lighting control and audiovisual recording system.

2. Description of the Related Art

Theatrical and stage productions and shows are highly dependent upon sources of very strong and/or bright lighting for various purposes and scenes. Generally, very strong lighting is required in a darkened theater to highlight the performers and/or scenery in order to provide good contrast for the audience during a live performance. Bright lighting is also required when filming motion picture scenes in order to provide sufficient exposure for the film or electronic video recording means. Moreover, lighting of various colors is often used in certain areas of the production and/or at certain times in order to set a mood and/or to highlight or emphasize a specific area of the stage and/or performer(s).

The use and corresponding control of such lighting has become ever more sophisticated and complex as theatrical technology has advanced over the years. Lighting is now generally controlled by what is known as a “DMX 512” controller. The term “DMX 512” actually refers to the standard for the device, i.e., Digital Multiplex, 512 units of information. A number of such controllers are manufactured by various commercial enterprises and are commonly used to control not only the intensity or brightness of individual lights in a lighting array having a plurality of lights, but also other effects, such as remote control of the location and movement of mobile lights, the control of fog machines, etc. It has become commonplace for large and/or sophisticated stage and motion picture productions to require multiple DMX 512 control boards or panels in order to control all of the various aspects of the lighting and special effects employed.

As a result, the director of the theatrical production often finds it difficult to direct a scene and/or critique the acting in the scene while simultaneously attempting to control the lighting of the scene. Accordingly, specialized personnel are often employed to set and control such lighting, but this removes the direct control of the lighting from the director of the production. The director may turn his or her attention either to the presentation of the scene by the actors and actresses or to the nuances of the lighting of the scene, but will generally find it difficult to impossible to cover both aspects of the production simultaneously.

A number of devices and systems for the control of theatrical lighting and special effects have been developed in the past. An example of such is found in German Patent Publication No. 19,825,837, published on Dec. 16, 1999. This publication describes (according to the drawings and English abstract) a theatrical lighting control system with a gantry camera and computer for recording the production. The system permits the production scene to be compared with an exemplary scene for adjustment of the lighting.

None of the above inventions and patents, taken either singly or in combination, is seen to describe the instant invention as claimed. Thus, a portable theatrical lighting control and audiovisual recording system solving the aforementioned problems is desired.

### SUMMARY OF THE INVENTION

The portable theatrical lighting control and audiovisual recording system comprises a series of three DMX 512 control panels or boards in a single portable case, along with various additional components. The case contains the aforementioned DMX 512 format lighting control panels, a video monitor and controls therefor, a miniature video camera, a DVD recorder and player, an external audio speaker, and various ports for peripherals, such as a headset, microphone, printer, keyboard, computer mouse, etc. The removable lid or cover includes a built-in storage tray for the carriage of the various electrical cords and cables required for the operation of the device.

The case and lid of the system include a pair of carrying handles thereon for portability of the device. When the system is to be deployed, it is positioned with the lid or cover oriented generally upward, and the lid is removed for access to the panels and other controls therein. When the case is oriented in this manner, the back panel or wall of the case is oriented vertically and clear of the underlying surface to permit the various electrical cords and cables to be plugged into corresponding sockets and ports in this rearward panel of the case. The device or system, thus deployed, permits the director of the theatrical production to control the lighting and/or other technical aspects from one location as he or she directs the performers during the production. When the performance ends, the director and/or other crew may disconnect the various cables and store them within the storage tray in the lid or cover, and the cover may be secured to the case for transport or storage of the device. The DVD recording may be played back for viewing via any compatible video system, or may alternatively be viewed using the monitor of the system when the system is actuated.

These and other features of the present invention will become readily apparent upon further review of the following specification and drawings.

### BRIEF DESCRIPTION OF THE DRAWINGS

FIG. 1 is a front perspective view of a portable theatrical lighting control and audiovisual recording system according to the present invention, shown with the lid removed from the case to show the components thereof.

FIG. 2 is a front perspective view of the portable theatrical lighting control and audiovisual recording system according to the present invention, shown with the front panels removed from the case to show the internal electronic components.

FIG. 3 is a rear perspective view of the portable theatrical lighting control and audiovisual recording system according to the present invention, shown with the lid installed on the case.

FIG. 4 is a front perspective view of the portable theatrical lighting control and audiovisual recording system according to the present invention, shown with the lid installed.

FIG. 5 is a perspective view of the lid of the portable theatrical lighting control and audiovisual recording system according to the present invention, the lid being inverted to show provisions for storage for various electrical power and communication cords associated with the device.

Similar reference characters denote corresponding features consistently throughout the attached drawings.

### DETAILED DESCRIPTION OF THE PREFERRED EMBODIMENTS

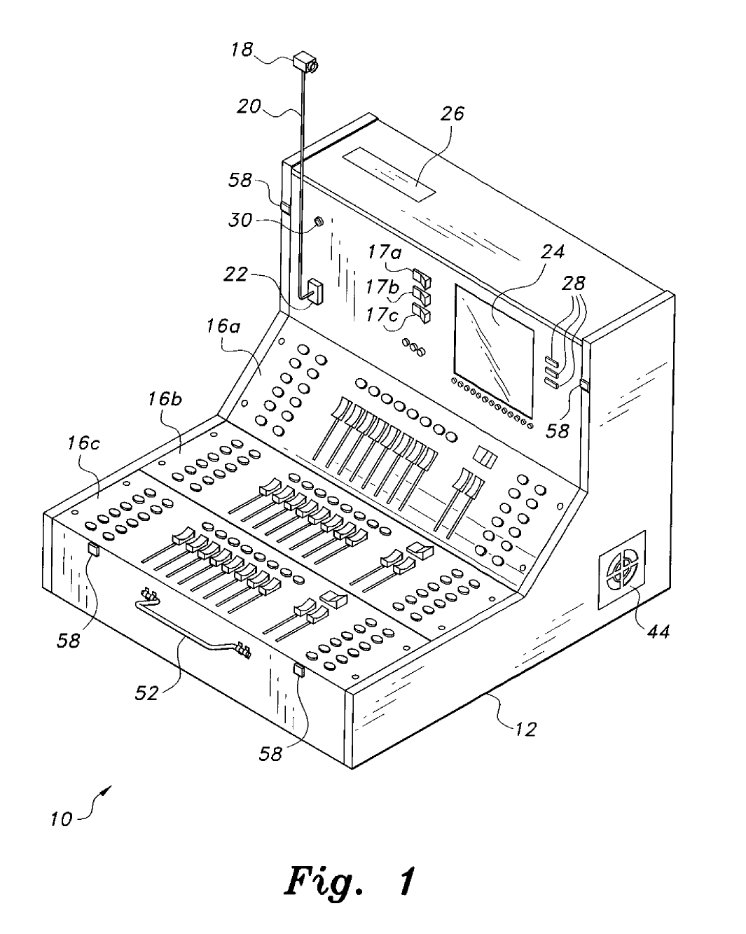

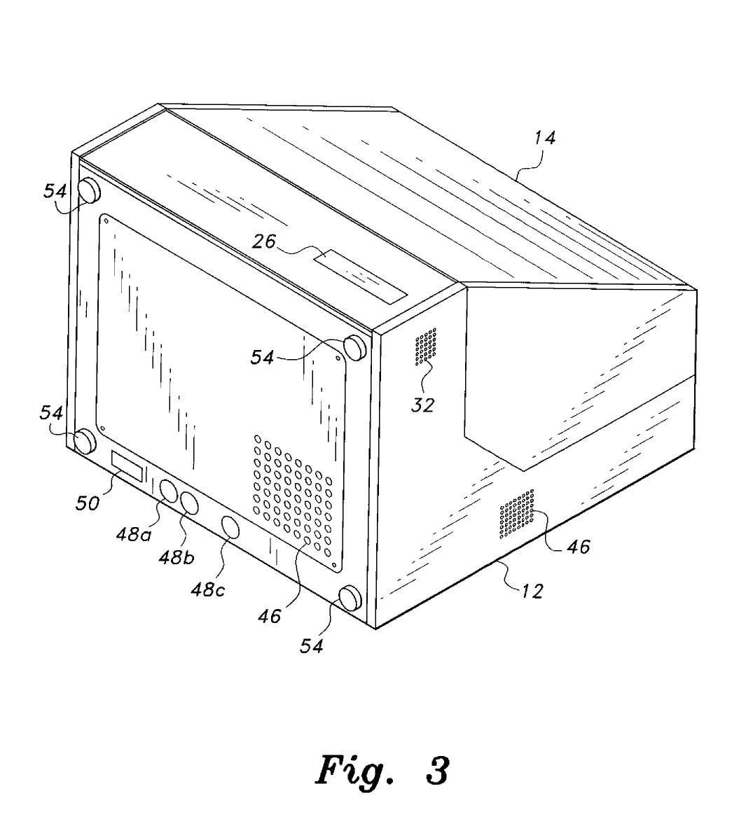

The portable theatrical lighting control and audiovisual recording system includes a number of different audiovisual control and recording components, all contained in a single portable carrying case to facilitate setup and control of lighting and other devices involved in theatrical and film productions. FIG. 1 of the drawings provides a perspective view of the portable theatrical lighting control and audiovisual recording system 10, shown with its lid or cover removed to illustrate many of the components included therewith. The various components of the system 10 are installed within a portable carrying case 12, the removable lid or cover 14 being illustrated in FIGS. 3 through 5.

The case 12 includes a plurality of DMX 512 lighting control panels 16a, 16b, and 16e housed therein. The DMX 512 lighting control panels 16a, 16b, and 16e are conventional units. Although only a single such lighting control panel or perhaps two such panels might be incorporated in the system 10, preferably three such panels 16a through 16e are incorporated in order to provide the range of control often required of relatively complex modern theatrical and film productions. The control panels 16a, 16b, 16c may be daisy-chained by using a cable to connect one DMX control panel to the next so that all the lighting equipments may be controlled by a single chain of cables, if desired, as known in the art. In some instances only a single DMX 512 lighting control panel might be used in a production, even though three such panels are provided with the system 10. A series of switches, e.g., 17a, 17b, and 17c are included in the upper panel of the system 10 to control power to the respective DMX 512 panels 16a, 16b, and 16c.

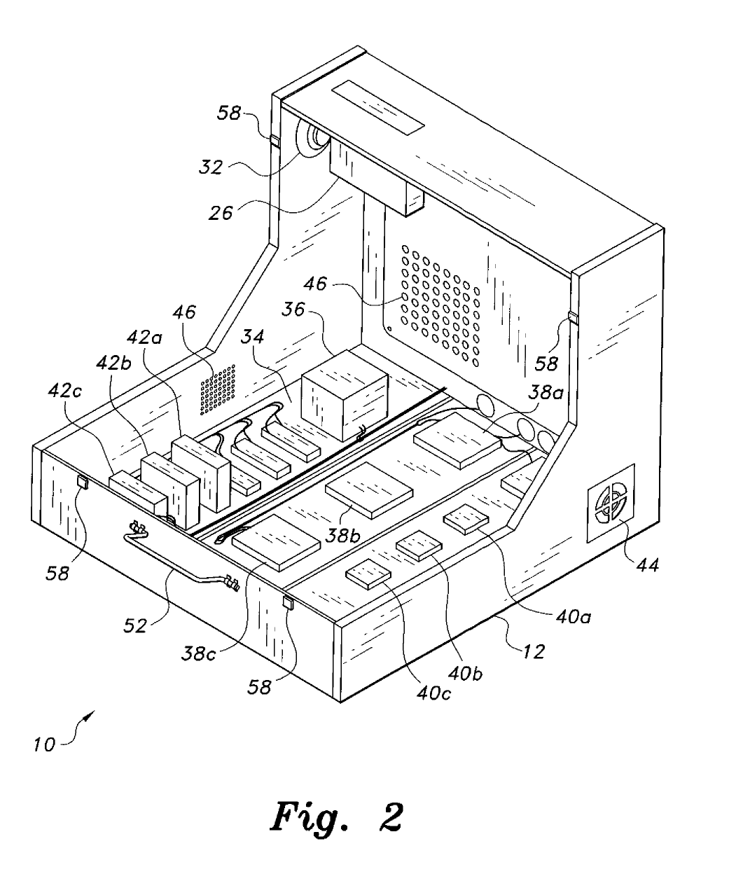

A miniature video camera 18 is mounted on the distal end of a camera support arm 20. The camera support arm 20, in turn, is pivotally mounted on a bracket or base 22 on the upper panel of the system 10. The arm 20 may be pivoted or rotated to a generally horizontal position on the order of 90° from that shown in FIG. 1 to retract and store the camera 18 and support arm 20 within the case 12 when not in use. The camera 18 enables the director or other person involved with the theatrical production to record the production for later review and/or critique of the performance, if desired. The recording means may comprise a conventional digital video disc (DVD) recording system 26 (FIG. 2), the disc insertion port of which is illustrated in FIG. 1. A video monitor 24 is installed in the upper panel of the system 10 to allow the director or other person(s) to observe the scene(s) as seen live by the camera 18 to observe lighting effects to determine any adjustments needed, which may be made using the control panels 16a, 16b, 16c. It will be understood that a DMX control system may be used to control fixed light fixtures (generally through a dimmer), moving light fixtures, strobe lights, fog machines, projectors, or other accessories used to produce visual effects on a theatrical stage.

The upper panel of the system 10 includes various additional features to expand the utility of the system. A plurality of USB ports 28 are provided for the attachment of various peripheral components, such as a microphone, printer, keyboard, computer mouse, and/or perhaps other peripheral devices. An audio output port or receptacle 30 is also provided for the connection of a headset or the like to the system 10, enabling the director or other party to listen to the audio recorded during the performance. Alternatively, a speaker 32 (shown in FIG. 2) is provided in the case 12 to enable others to hear the audio output without need for headphones.

FIG. 2 of the drawings provides a view of the internal components of the system 10, the three DMX 512 units 16a through 16c and the upper panel of the system 10 being removed in the view of FIG. 2. The case 12 includes a computer motherboard 34 installed therein, the motherboard 34 having a plurality of electronic and computer components installed thereon. A central processing unit (CPU) 36 is installed on the motherboard 34, which communicates electronically and conventionally with the various lighting control panels 16a through 16c, the video camera 18, the video monitor 24, the digital video recorder 26, and other electronic components of the system 10. Three video display converters 40a, 40b, and 40c are provided in the case 12 to receive and process video output received from the camera 18. Similarly, a plurality of audio recorders and players 42a, 42b, and 42c is provided in the case 12 to record and provide for playback of the audio portion of the theatrical production. Additional conventional electronic components, e.g., power supplies, etc., may be provided within the case 12 according to the specific configurations and requirements of the components installed. A cooling fan 44 is provided in the case 12 to exhaust the heated air produced by the electronic components within the case 12, and other ventilation ports 46 may be provided as well.

FIG. 3 of the drawings provides a perspective view of the back side or surface of the case 12, i.e., oriented substantially 180° from the orientation illustrated in FIGS. 1 and 2. This face or surface of the case 12 includes three outlets 48a, 48b, and 48c that communicate electronically with the respective DMX 512 control panels 16a, 16b, and 16c, to which the various lighting and/or other systems may be connected for control by the panels 16a through 16c. A power plug receptacle 50 is also provided for connection of the system 10 to a conventional source of electrical power for its operation.

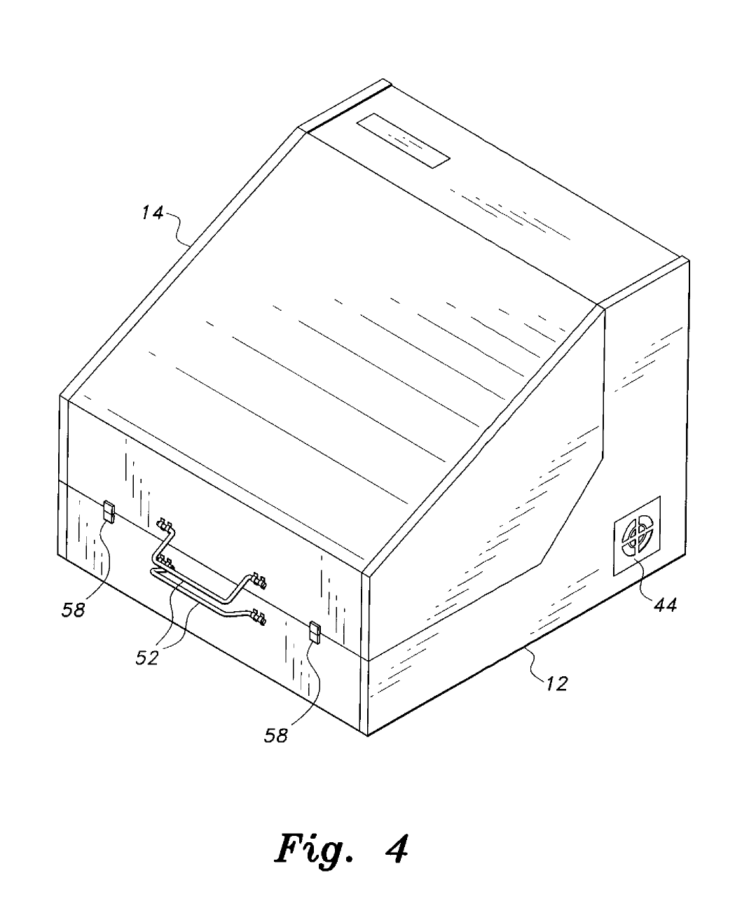

The portable theatrical lighting control and audiovisual recording system 10 is normally oriented for operation as illustrated in FIGS. 1 through 4, with the back surface of the case 12 oriented vertically to facilitate the connection of the various electrical cords and cables to the outlets 48a through 48c and the receptacle 50. However, the case 12 with its lid or cover 14 installed thereon is normally carried by means of the handles 52 (shown in FIGS. 1, 2, 4, and 5) extending from the case 12 and lid 14, with the back surface of the case 12 illustrated in FIG. 4 being oriented downwardly. Accordingly, pads or feet 54 are provided on the rearward face of the case 12 to support the system 10 when it is positioned with the handles 52 oriented upwardly for carriage or storage.

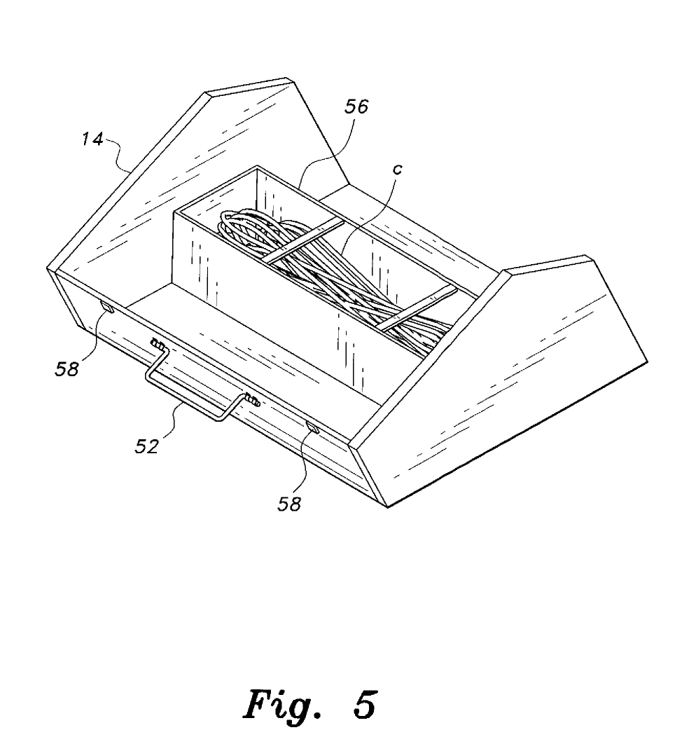

FIG. 5 provides an illustration of the internal structure of the lid or cover 14. A storage tray 56 is provided within the lid 14 for the storage of the various electrical cords and cables required for the operation of the system 10. Thus, when the electrical cables and cords C are stored within the storage tray 56 and the lid or cover 14 is secured to the case 12 by means of the conventional latches 58 illustrated generally in the various drawings, the portable theatrical lighting control and audiovisual recording system 10 may be carried or stored conveniently as a single unit. Deployment of the apparatus is easily accomplished by carrying the closed system 10 to the site of the performance, removing the cover or lid 14 from the case 12, and removing the various cords and cables C from their storage tray 56 within the lid 14 and connecting them to the various ports and receptacles 48a through 48c and 50 shown in FIG. 3 of the drawings. The cords and cables C are then connected to the appropriate power source and lighting systems, with the system 10 then being ready for operation. The director or other responsible party may then have complete control of the lighting and perhaps other theatrical systems controlled by the DMX 512 boards 16a through 16c of the system 10 from a central location while being able to direct the performance simultaneously.

It is to be understood that the present invention is not limited to the embodiments described above, but encompasses any and all embodiments within the scope of the following claims.

I claim:

1. A portable theatrical lighting control and audiovisual recording system, comprising:
a portable carrying case;
a lid removably disposed upon the case;
at least one lighting control panel disposed within the case;
a miniature video camera retractably extending from the case;
a video monitor disposed within the case;
a digital video recorder disposed within the case; and
a computer disposed within the case, the computer communicating electronically with the lighting control panel, the video camera, the video monitor, and the digital video recorder.

2. The portable theatrical lighting control and audiovisual recording system according to claim 1, wherein the at least one lighting control panel comprises a plurality of lighting control panels.

3. The portable theatrical lighting control and audiovisual recording system according to claim 1, further comprising an audio recorder and player disposed within the case, the computer communicating electronically with the audio recorder and player.

4. The portable theatrical lighting control and audiovisual recording system according to claim 1, further comprising an audio speaker mounted in the case, the computer communicating electronically with the audio speaker.

5. The portable theatrical lighting control and audiovisual recording system according to claim 1, further comprising a plurality of USB ports mounted in the case, the computer communicating electronically with the USB ports.

6. The portable theatrical lighting control and audiovisual recording system according to claim 1, further comprising at least one audio output port mounted in the case, the computer communicating electronically with the audio output port.

7. The portable theatrical lighting control and audiovisual recording system according to claim 1, further comprising a camera support arm pivotally disposed within and selectively extending from the case, the miniature video camera being mounted on the camera support arm.

8. The portable theatrical lighting control and audiovisual recording system according to claim 1, further comprising an electrical cord and cable storage tray disposed within the lid.

9. A portable theatrical lighting control and audiovisual recording system, comprising:
a portable carrying case;
a lid removably disposed upon the case;
a plurality of lighting control panels disposed within the case;
a camera support arm pivotally disposed within and selectively extending from the case, the camera support arm having a distal end;
a miniature video camera disposed upon the distal end of the camera support arm;
a video monitor disposed within the case;
a digital video recorder disposed within the case; and
a computer disposed within the case, the computer communicating electronically with the plurality of lighting control panels, the video camera, the video monitor, and the digital video recorder.

10. The portable theatrical lighting control and audiovisual recording system according to claim 9, further comprising an audio recorder and player disposed within the case, the computer communicating electronically with the audio recorder and player.

11. The portable theatrical lighting control and audiovisual recording system according to claim 9, further comprising an audio speaker disposed with the case, the computer communicating electronically with the audio speaker.

12. The portable theatrical lighting control and audiovisual recording system according to claim 9, further comprising a plurality of USB ports disposed with the case, the computer communicating electronically with the USB ports.

13. The portable theatrical lighting control and audiovisual recording system according to claim 9, further comprising at least one audio output port disposed with the case, the computer communicating electronically with the audio output port.

14. The portable theatrical lighting control and audiovisual recording system according to claim 9, further comprising an electrical cord and cable storage tray disposed within the lid.

15. A portable theatrical lighting control and audiovisual recording system, comprising:
a portable carrying case;
a lid removably disposed upon the case;
at least one lighting control panel disposed within the case;
a camera support arm pivotally disposed within and selectively extending from the case, the camera support arm having a distal end;
a miniature video camera disposed upon the distal end of the camera support arm;
a video monitor disposed within the case;
a digital video recorder disposed within the case;
an audio recorder and player disposed within the case; and
a computer disposed within the case, the computer communicating electronically with the lighting control panel, the video camera, the video monitor, the digital video recorder, and the audio recorder and player.

16. The portable theatrical lighting control and audiovisual recording system according to claim 15, wherein the at least one lighting control panel comprises a plurality of lighting control panels.

17. The portable theatrical lighting control and audiovisual recording system according to claim 15 further comprising an audio speaker disposed with the case, the computer communicating electronically with the audio speaker.

18. The portable theatrical lighting control and audiovisual recording system according to claim 15, further comprising a plurality of USB ports disposed with the case, the computer communicating electronically with the USB ports.

19. The portable theatrical lighting control and audiovisual recording system according to claim 15 further comprising at least one audio output port disposed with the case, the computer communicating electronically with the audio output port.

20. The portable theatrical lighting control and audiovisual recording system according to claim 15, further comprising an electrical cord and cable storage tray disposed within the lid.
